(19) United States
(12) Patent Application Publication
(10) Pub. No.: US 2005/0030672 A1
(43) Pub. Date: Feb. 10, 2005

(54) Method of screening head based on contact recording type magnetic head and method of measuring contact force of magnetic head

(75) Inventor: Kan Takahashi, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/910,798

(22) Filed: Aug. 4, 2004

(30) Foreign Application Priority Data
Aug. 8, 2003 (JP) 2003-290480

(51) Int. Cl. G11B 5/48; G11B 21/16; G11B 5/56; G11B 21/24

(52) U.S. Cl. 360/290

(57) ABSTRACT

A head gimbal assembly is prepared, a proximal end portion of a suspension therein is supported at a given mounting height above a surface of an inspection disk, and a magnetic head of the head suspension is brought into contact with the surface of the inspection disk. In this state, the inspection disk is rotated, and separation of the magnetic head from the inspection disk surface is detected with the mounting height of the suspension and/or the rotational frequency of the inspection disk changed. The mounting height and the rotational frequency of the inspection disk are converted into a contact force of the magnetic head to measure the contact force when the head is separated from the inspection disk surface.

### CROSS-REFERENCE TO RELATED APPLICATIONS

This application is based upon and claims the benefit of priority from prior Japanese Patent Application No. 2003-290480, filed Aug. 8, 2003, the entire contents of which are incorporated herein by reference.

### BACKGROUND OF THE INVENTION

1. Field of the Invention

This invention relates to a method of screening heads based on a contact force of a contact recording type magnetic head used in a magnetic disk drive and a method of measuring a contact force of a head with respect to the magnetic disk.

2. Description of the Related Art

There has recently been provided a contact recording type magnetic head which is used in a magnetic disk drive and is records on or reproduces information from a magnetic disk while being in contact with the surface of the magnetic disk, as described in Jpn. Pat. Appln. KOKAI Publication No. 8-249623. One of the most important design parameters for the contact recording type magnetic head is the contact force between the magnetic head and the magnetic disk. Dispersions that are attributable to errors in manufacture and an increment of the contact force under a reduced-pressure condition are accumulated to form a contact force distribution. The contact force is designed lest the upper limit of the distribution exceed an upper limit value that is determined by wear reliability and lest the lower limit of the distribution be lower than a lower limit value that is determined by contact stability. In manufacturing processes for magnetic disk drives including magnetic heads, however, it is inevitable that some of the heads will be considerably deviated from the contact force distribution from various causes.

After the magnetic head is set in the magnetic disk drive, according to a possible conventional method of contact force measurement, the whole drive is pressurized as a lifting start pressure is measured by determining the magnetic spacing of auto-gain control (AGC) signals and the like. By doing this, a lifting start pressure is measured, and a contact force at normal pressure is obtained from its dependency on the atmospheric pressure.

According to this method, however, large-scale equipment is separately required to pressurize the whole unit, and the contact force cannot be measured before the magnetic head is set in the magnetic disk drive. If the contact force of the magnetic head is smaller than a given value, moreover, the head cannot stably slide in contact with the surface of the magnetic disk, so that fluctuation of the magnetic spacing or the like may be caused. It is highly possible, therefore, to detect the contact force by generation of abnormal signals or the like even in a pre-delivery inspection. If the contact force is greater than a given value, however, it cannot be detected unless a prolonged abrasion test is conducted. Actually, therefore, defective products cannot be detected in the pre-delivery inspection.

### BRIEF SUMMARY OF THE INVENTION

According to an aspect of the present invention, a method of screening a contact recording type magnetic head based on a contact force of the magnetic head, comprising: preparing a head gimbal assembly having a suspension and a magnetic head supported on a distal end portion of the suspension by a gimbals spring; rotating an inspection disk with a proximal end portion of the suspension supported at a given mounting height for a surface of the inspection disk and with the magnetic head in contact with the surface of the inspection disk; and detecting separation of the magnetic head from the surface of the inspection disk with the rotational frequency of the inspection disk increased to a given value, thereby screening the magnetic head based on the performance of the separation.

According to another aspect of the invention, a method of measuring a contact force of a contact recording type magnetic head, comprising: preparing a head gimbal assembly having a suspension and a magnetic head supported on a distal end portion of the suspension by a gimbals spring; rotating an inspection disk with a proximal end portion of the suspension supported at a given mounting height for a surface of the inspection disk and with the magnetic head in contact with the surface of the inspection disk; changing at least one of the mounting height of the suspension and the rotational frequency of the inspection disk so as to separate the magnetic head from the surface of the inspection disk; detecting at least one of the mounting height of the suspension and the rotational frequency of the inspection disk, at which the magnetic head separates from the surface of the inspection disk; and converting the detected mounting height and/or the rotational frequency of the inspection disk into the contact force of the magnetic head, thereby measuring the contact force.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a contact force-rotational frequency characteristic of a magnetic head having a reference contact force;

FIG. 2 is a diagram showing a contact force-rotational frequency characteristic of the magnetic head obtained after the mounting height of the head is changed;

FIG. 3 is a diagram showing the upper and lower limits of the contact force of a contact recording type magnetic head;

FIG. 4 is a diagram showing a distribution of the contact force of the contact recording type magnetic head;

FIG. 5 is a side view schematically showing a measuring device according to an embodiment of the invention;

FIG. 6 is a side view showing a head gimbal assembly including a contact recording type magnetic head;

FIG. 7 is a diagram showing a contact force-rotational frequency characteristic curve and a lifting start line used in measurement for a contact recording type magnetic head having a contact force smaller than the reference rotational frequency;

FIG. 8 is a diagram showing a contact force-rotational frequency characteristic curve and a lifting start line used in measurement for a contact recording type magnetic head having a contact force greater than the reference rotational frequency; and

FIG. 9 is a diagram showing contact force-rotational frequency properties of the magnetic head and a plurality of straight lines representing separation rotational frequencies.

### DETAILED DESCRIPTION OF THE INVENTION

Referring now to the accompanying drawings, there will be described in detail a method of measuring the contact force of a contact recording type magnetic head according to an embodiment of this invention and a contact force measuring device used for this measuring method.

The basic principle of the method of measuring a contact force will be described first. The force of contact of the contact recording type magnetic head on a magnetic disk depends on the rotational frequency of the magnetic disk. If the rotational frequency of the magnetic disk is raised, the pressure of an air lubrication film that is generated in a gap between the disk and the head increases. Thereupon, a force is produced in the direction to lift or separate the head from the disk, so that the contact force of the head lowers correspondingly. Thus, the magnetic head is separated from the magnetic disk by increasing the rotational frequency of the disk that is rotating at a reference frequency with the contact-type head sliding thereon. The contact force of the magnetic head with the disk at the reference rotational frequency can be calculated according to the rotational frequency of the disk being separated and contact force-rotational frequency dependency that is previously settled by calculation when the head is designed. The reference rotational frequency is a rotational frequency of the magnetic disk that is used when the magnetic head is actually set in a magnetic disk drive.

The contact force of the contact recording type magnetic head also has a dependency on a mounting height (hereinafter referred to as ZH) for the magnetic disk. If the ZH is small, a force (suspension load) of the suspension to press the head against the disk increases, while the difference between a loaded posture angle and an initial mounting angle lessens. Correspondingly, a moment that presses an exposed end of the head against the disk around the center of gravity of the head lowers, so that contact force of the head diminishes. If the ZH is great, in contrast with this, the contact force increases.

As the ZH is lowered gradually from the reference height by utilizing this character, separation between the magnetic head and the magnetic disk is detected. If this is done, the contact force of the head at the reference mounting height can be calculated according to the mounting height and the contact force-rotational frequency dependency that is previously settled by calculation when the head is designed.

The contact and separation between the magnetic head and the magnetic disk can be determined by detecting changes of reproducing signal characteristic values, such as a reproducing signal output (hereinafter referred to as TAA) from the head, signal half-width (hereinafter referred to as PW50), etc. More specifically, the reproducing signal characteristic values of the magnetic head vary depending on the state, contacted or separated, of the head, so that the separation of the head can be detected by these changes.

Alternatively, the separation of the magnetic head may be detected by determining an output signal from an acoustic emission (hereinafter referred to as AE) sensor, which is set near a mounting portion of the suspension that carries the magnetic head thereon. Since the output signal from the AE sensor substantially varies depending on the state, contacted or separated, of the magnetic head, the head separation can be detected by change of the output signal.

FIG. 1 shows an example of the contact force-rotational frequency dependency of a contact recording type magnetic head that is designed with a reference contact force of 150 mgf. It illustrates change of the contact force of the head caused when the rotational frequency of the magnetic disk is changed. The reference contact force is a contact force of the magnetic head for the rotational frequency (hereinafter referred to as reference rotational frequency) of the magnetic disk used in the magnetic disk drive.

In this example of the magnetic head, the reference contact force obtained with the reference rotational frequency of 4,200 rpm is about 150 mgf. The contact force tends to lessen monotonously as the rotational frequency increases. A substantially linear relation is established with the reference or higher rotational frequency. In order to separate or lift the magnetic head from the magnetic disk with the contact force at zero, however, the rotational frequency of the disk must be raised to tens of thousands of rpm, which is not practical.

Accordingly, the ZH is made smaller than the reference height to lessen the contact force for the reference rotational frequency. By doing this, the magnetic head can be lifted with a lower rotational frequency. More specifically, the contact force lessens at a rate of several mgf/μm if the ZH is reduced. If the head is mounted with the ZH lessened by several tens of μm, therefore, even the magnetic head that has the characteristic shown in FIG. 1 can be lifted above the magnetic disk with a lower rotational frequency.

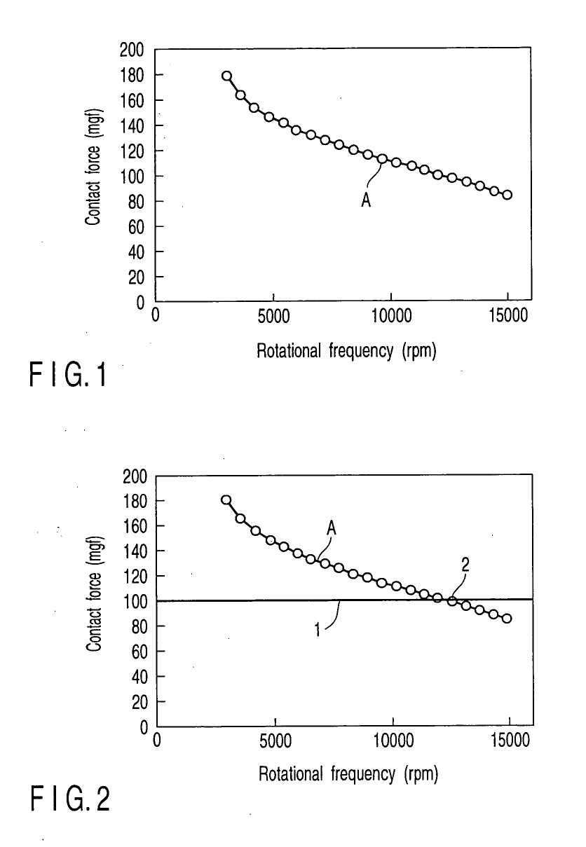

FIG. 2 shows a contact force-rotational frequency characteristic of the magnetic head with the ZH smaller by 50 μm than the reference height. The sensitivity of the ZH for the contact force-rotational frequency is 2 mgf/μm. If the ZH is lowered by 50 μm, a lifting start line 1 on which the contact force with which the magnetic head is lifted is zero is upwardly moved parallel by 50 μm×2 mgf/μm=100 mgf. If the actual contact force of the head is equal to the reference contact force, the head is lifted at an intersection 2 (about 12,600 rpm, hereinafter referred to as reference lifting start frequency) between the lifting start line 1 and a characteristic curve A. If the actual contact force is smaller than the reference contact force, the head is lifted at a rotational frequency lower than the reference lifting start frequency. If the actual contact force is greater than the reference contact force, the head is lifted at a rotational frequency higher than the reference lifting start frequency. By suitably selecting the ZH, a satisfactory contact measuring range can be obtained within an allowable rotational frequency range of the measuring device, and the contact force can be measured by the same method.

In general, a contact recording type magnetic head is mounted on the distal end portion of a suspension by a gimbals spring, and forms a head gimbal assembly (hereinafter referred to as HGA). In the pre-delivery stage, the contact force of the magnetic head of the HGA is subject to dispersions that are attributable to errors in mounting positions of the head and the suspension, angular errors, errors in groove depth on the ABS surface of a slider, and other errors caused during manufacturing processes. According to the contact force measuring method based on the principle described above, therefore, the magnetic head need not be detached from the HGA when its contact force is measured, and defective products can be screened in the pre-delivery stage.

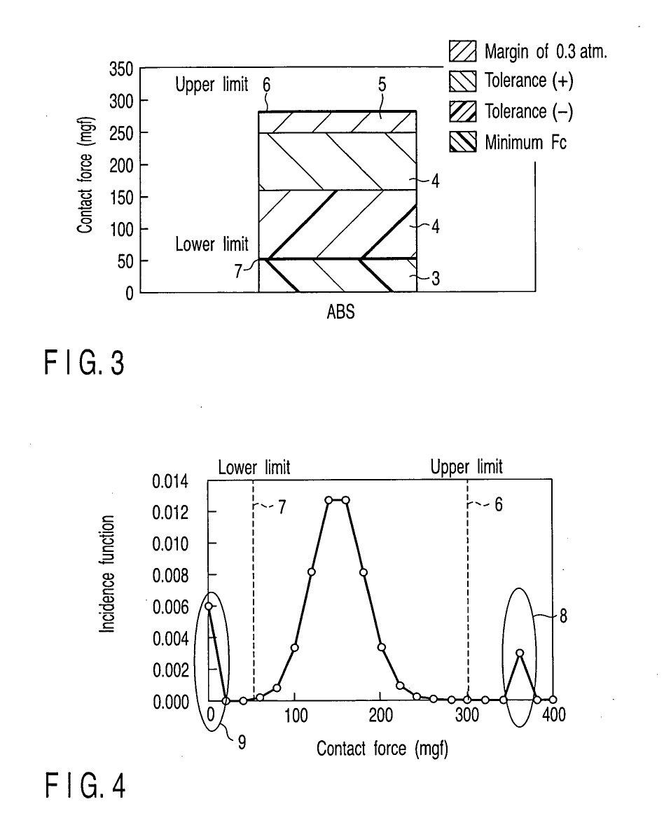

The contact force design of the contact recording type magnetic head will now be described with reference to FIGS. 3 and 4. FIG. 3 illustrates the design concept of the contact force of the contact recording type magnetic head. The contact force is designed to be restricted within the range between an upper limit value 6 and a lower limit value 7, in consideration of a minimum contact force 3 with which the head cannot be excited to behave disorderly by an undulating motion of the magnetic disk, dispersions 4 attributable to errors in manufacture, and an increment 5 of the contact force in a reduced-pressure environment. By doing this, the reliability of the magnetic disk drive can be ensured. The upper and lower limit values 6 and 7 are determined in the following manner.

(1) The upper limit value of the contact force is set to a value such that the magnetic head can enjoy good wear reliability for a prolonged period. If this value is too high, a protective film of the head wears so fast that the head is damaged when a recording/reproducing element is exposed.

(2) The lower limit value of the contact force is set to a value such that the head can resist a vertical exciting force that is attributable to a fine undulating motion of the magnetic disk.

FIG. 4 shows an example of the contact force distribution of the magnetic head. The contact force has the illustrated distribution that involves its dispersions attributable to errors in manufacture. If the magnetic head is designed so that the contact force distribution is restricted within the range between the upper and lower limit values 6 and 7, defective products are produced inevitably. As shown in FIG. 4, the defective products include products 8 whose contact force is greater than the upper limit value 6 and products 9 whose contact force is smaller than the lower limit value 7. In the defective products 9 with the contact force smaller than the lower limit value 7, the magnetic head cannot stably slide in contact with the magnetic disk (or repeats contact and jumping). Accordingly, the magnetic spacing fluctuates to hinder recording and reproduction. Thus, the products 9 can be detected with high possibility in an inspection before the device is delivered. However, the defective products 8 with the contact force greater than the upper limit value 6 cannot be easily detected in the pre-delivery inspection.

The contact force measuring method according to the present embodiment is applicable to the detection of those unavoidable defective products and contact force screening in the stage of delivery of the magnetic head. The following is a detailed description of this contact force measuring method along with the measuring device therefor.

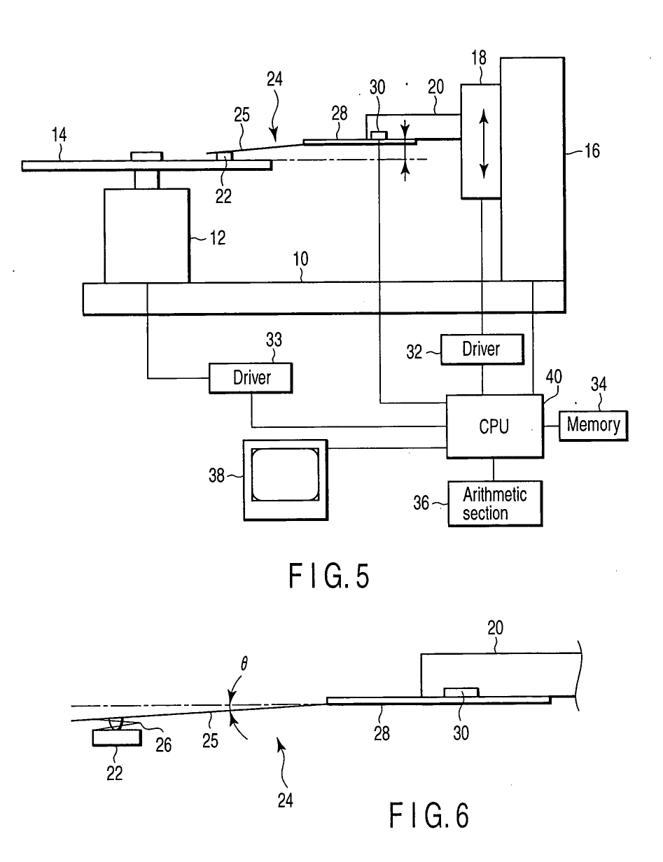

As shown in FIG. 5, the measuring device is constructed so that it is also usable as an electrical property inspection device in a magnetic head inspection process. This measuring device has a spindle motor 12 provided on a base 10. An inspection disk 14 is supported substantially horizontally for rotation on the spindle of the motor 12. A supporting post 16 is set up on the base 10, and a mounting arm 20 is supported on the post by a lift mechanism 18. The mechanism 18 enables the arm 20 to ascend and descend in the vertical direction.

The arm 20 is fitted with an HGA 24 that is provided with a contact recording type magnetic head 22 as an object of measurement. As shown in FIGS. 5 and 6, the HGA 24 comprises an elongate suspension 25 formed of a thin leaf spring, the magnetic head 22, and an arm 28. The magnetic head 22 is mounted on the distal end portion of the suspension by a gimbals spring 26. In this case, the arm 28 is attached to the proximal end portion of the suspension. The suspension 25 and the arm 28 may be formed integrally with each other. The suspension 25 has a given static pitch θ with respect to the arm 28. Based on this value, it generates a force to press the contact recording type magnetic head 22 against a surface of the magnetic disk.

The HGA 24 is set in the measuring device with the arm 28 mounted on the mounting arm 20. The contact recording type magnetic head 22 is in contact with the surface of the inspection disk 14. The mounting height ZH of the HGA 24 above the surface of the disk 14 can be changed by adjusting the height position of the arm 20 with the lift mechanism 18.

Further, the measuring device comprises an AE sensor 30, drivers 32 and 33, memory 34, arithmetic section 36, monitor 38, control unit 40, etc. The AE sensor 30 is mounted on the mounting arm 20 and measures acoustic emission from the arm 28. The drivers 32 and 33 drive the lift mechanism 18 and the spindle motor 12, respectively. The memory 34 is stored with the contact force-rotational frequency characteristic of the magnetic head 22, a contact force-mounting height characteristic, etc. The arithmetic section 36 converts a measured value, rotational frequency, and mounting height into the contact force of the magnetic head. The monitor 38 displays measurement results. The control unit 40 controls the operation of the whole measuring device. A reproducing output from the magnetic head 22 is applied to the input of the control unit 40.

Normally, in a pre-delivery inspection process for the magnetic head, electrical properties of the magnetic head, including the PW50 and TAA, are measured with use of the measuring device, and magnetic head screening is carried out according to obtained electric property specifications. In the inspection of the contact recording type magnetic head, defective magnetic heads are screened by the aforesaid method based on the contact force after they are screened with the electrical properties. The following is a description of the contact force measuring method and a defective magnetic head screening method.

First, the HGA 24 having the magnetic head 22 to be measured is prepared, and it is mounted on the arm 20 of the measuring device. The magnetic head 22 is supposed to have the contact force-rotational frequency characteristic shown in FIG. 1. For simplicity, this characteristic is approximately represented by a straight line, and the rotational frequency sensitivity of the contact force, that is, its inclination, is' supposed to be a. In this example, α≈0.006 mgf/rpm is given, and this a is stored in advance in the memory 34.

Subsequently, the HGA 24 is adjusted to the reference mounting height ZH by the lift mechanism 18 before the contact force measurement. The inspection disk 14 is rotated at the reference rotational frequency, and the electrical properties of the magnetic head 22 are measured. An index value for the magnetic spacing obtained by this measurement, e.g., the half-width PW50 of the reproducing signal, is stored in the memory 34. Then, the contact force is measured in two stages in the following manner. For example, measurement is made on magnetic heads whose contact force is smaller than the reference contact force and ones whose contact force is greater than the reference contact force.

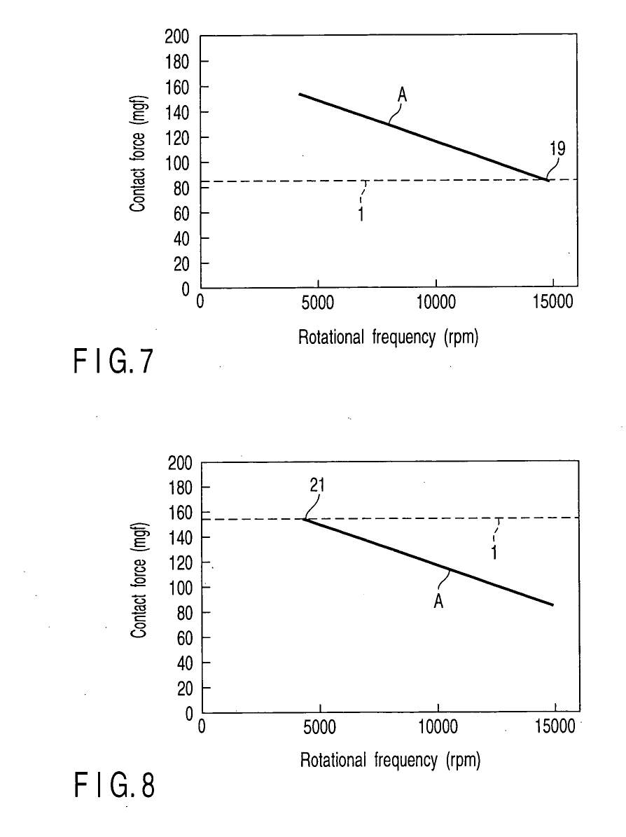

Let it be supposed that the upper limit value of the rotational frequency of the measuring device is, e.g., 15,000 rpm and the magnetic head 22 if the contact force of the magnetic head 22 is smaller than the reference contact force, as shown in FIG. 7, and that the magnetic head 22 is loaded on the inspection disk 14. Thereafter, the ZH is lowered to a point 19 on which the intersection 2 between the characteristic curve A and the lifting start line 1 coincides with the upper limit value (15,000 rpm) of the rotational frequency. The decrease of the ZH is equal to a value that is obtained by dividing a contact force of 83 mgf at 15,000 rpm by a contact force-mounting height dependency. In this calculation, the contact force-mounting height dependency is given as 2 mgf/μm.

In this state, the rotational frequency of the inspection disk 14 is gradually increased from the reference rotational frequency as the half-width PW50 of the reproducing signal is measured in accordance with the reproducing output of the magnetic head 22. When the half-width PW50 becomes greater than the value obtained by the foregoing electrical property measurement, it is concluded that the magnetic head 22 is separated or lifted from the disk 14, and the then rotational frequency of the disk is stored as the lifting start frequency in the memory 34.

The arithmetic section 36 calculates the contact force of the magnetic head 22 from the detected lifting start frequency. A basic formula for the calculation is
Fc=(Rf−Rfn)×α+Fcn.

Here Fc is the contact force (mgf); Rf, lifting start frequency (rpm); Rfn, reference lifting start frequency (rpm, rotational frequency with which the reference contact force head is lifted at the set ZH); Fcn, reference contact force (=150 mgf); and α, rotational frequency sensitivity (=0.006 mgf/rpm).

If the magnetic head 22 starts to be lifted at 15,000 rpm, for example, Fc is
Fc=(15,000−15,000)×0.006+150=150 mgf,
so that the contact force of the head 22 is evidently coincident with the reference contact force of 150 mgf. If the magnetic head 22 starts to be lifted at 10,000 rpm, on the other hand, Fc is
Fc=(10,000−15,000)×0.006+150=120 mgf,
so that the contact force of the head 22 is evidently smaller than the reference contact force of 150 mgf.

If the rotational frequency of the inspection disk 14 is changed from the reference rotational frequency of 4,200 rpm to the upper-limit rotational frequency of 15,000 rpm, the lower limit of the measurable range of contact force is
Fc=(4,200−15,000)×0.006+150=85.2 mgf,
and the upper limit is the reference contact force of 150 mgf. If the measured contact force is not within the aforesaid range, it is necessary only that the previously set decrease of the ZH be adjusted. If the ZH is set so that the reference contact force head is lifted at 20,000 rpm, the contact force at 20,000 rpm is 53 mgf, so that the ZH must only be lowered by 53 (mgf)/2 (mgf/μm)=26.5 μm. In this case, the lower limit of the measurable range of contact force is
Fc=(4,200−20,000)×0.006+150=55.2 mgf,
and the upper limit is
Fc=(15,000−20,000)×0.006+150=120 mgf.

Then, if the contact force of the magnetic head 22 is greater than the reference contact force, the head 22 is loaded on the inspection disk 14. Thereafter, the ZH is lowered so that an intersection 21 between the characteristic curve A for the reference contact force of 150 mgf and the lifting start line 1 coincides with the upper limit value (15,000 rpm) of the rotational frequency. The decrease of the ZH is 150 (mgf)/2 (mgf/μm)=75 μm.

In this state, the rotational frequency of the inspection disk 14 is gradually increased from the reference rotational frequency in the same manner as aforesaid as the lifting of magnetic head 22 is detected by change of the half-width PW50 of the reproducing signal from the head 22. The then rotational frequency of the inspection disk is stored as the lifting start frequency in the memory 34. The arithmetic section 36 calculates the contact force of the magnetic head 22 from the detected lifting start frequency. As in the aforesaid case, a basic formula for the calculation is Fc=(Rf−Rfn)×α+Fcn, where Rfn=4,200 rpm.

If the lifting start frequency of the magnetic head 22 is 10,000 rpm, for example, Fc is
Fc=(10,000−4,200)×0.006+150=184.8 mgf,
so that the contact force of the head 22 is evidently greater than the reference contact force of 150 mgf.

If the rotational frequency of the inspection disk 14 is changed from the reference rotational frequency of 4,200 rpm to the upper-limit rotational frequency of 15,000 rpm, the lower limit of the measurable range of contact force is
Fc=(4,200−4,200)×0.006+150=150 mgf,
and the upper limit is
Fc=(15,000−4,200)×0.006+150=214.8 mgf.
If the measured contact force is not within the aforesaid range, it is necessary only that the ZH be lowered further. If the ZH is further lowered by 50 μm to be smaller by 125 μm than the reference mounting height, for example, a reference lifting start frequency corresponding to the ZH is 33 (rpm)=4,200 (rpm)−50 (μm)/2 (mgf/μm)/0.006 (mgf/rpm). The lower limit of the measurable range contact force is
Fc=(4,200−4,200)×0.006+150=150 mgf,
and the upper limit is
Fc=(15,000−33)×0.006+150=239.8 mgf.

According to the contact force measuring method and device arranged in this manner, the contact force of the contact recording type magnetic head can be measured easily and stably before the device is set in the magnetic disk drive. Defective products that are deviated from an allowable contact force distribution can be detected and rejected in the pre-delivery inspection for the contact recording type magnetic head. Therefore, the defective products can be quickly detected, and the yield of products can be improved. According to the measuring method and device described above, moreover, defective magnetic heads can be screened by only increasing one process after or before the conventional electrical property measurement. Thus, the measurement and screening can be carried out efficiently.

The separation or lifting of the magnetic head from the magnetic disk can be easily detected by the change of the half-width of the reproducing signal from the head without using any new measurement item. At the same time, the reproducing signal half-width PW50 is highly sensitive to the magnetic spacing, so that the contact and separation of the magnetic head can be detected with high accuracy. The separation of the magnetic head may be detected by change of the reproducing signal intensity (TAA) of the head, as well as by the change of the reproducing signal half-width. Also in this case, the same effect as the half-width produces can be obtained. Further, the separation of the magnetic head may be detected by change of the output signal from the AE sensor that is attached to the mounting portion of the HGA. In this case, the contact and separation of the magnetic head can be detected without using the electrical property values of the head.

With use of the contact force measuring method described above, magnetic heads that have excessive and scarce contact forces can be screened and rejected more easily in the pre-delivery inspection.

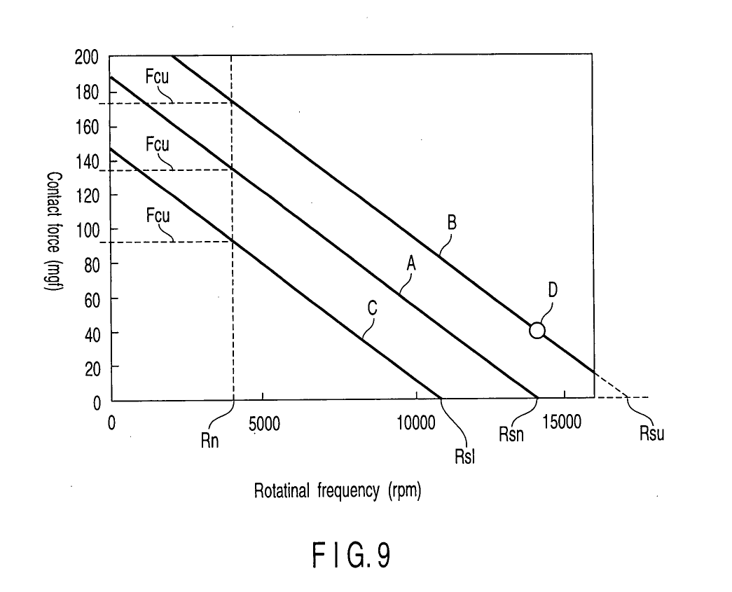

In contact force-rotational frequency properties shown in FIG. 9, a straight line A is supposed to represent a magnetic head with the reference contact force. In this case, a straight line B represents a magnetic head with a contact force greater than the reference contact force, and a straight line C represents a magnetic head with a contact force smaller than the reference contact force. In the description to follow, these straight lines will be referred to as separation straight lines. Readings of contact forces obtained when the straight lines cross a reference rotational frequency Rn indicate contact force values Fcn, Fcu and Fcl, individually. Separation contact forces are represented individually by points Rsn, Rsl and Rsu at which the separation straight lines A, B and C cross the axis of abscissa.

If the upper limit of the allowable rotational frequency of the measuring device is 15,000 rpm, Rsu cannot be measured because it exceeds the upper limit. In this case, the ZH must only be adjusted properly. If the ZH is lowered corresponding to 40 mgf in terms of the contact force, the axis of abscissa that forms intersections with the separation straight lines. In this case, an intersection D represents a separation rotational frequency.

The screening method will now be described with reference to FIG. 9. The following is a description of a case where the contact force to be screened is Fcl when scarce contact force heads are screened and rejected. Since the case where the screened contact force is Fc is represented by the straight line C, the separation rotational frequency Rsl lies on the intersection between the line C and the axis of abscissa for Fc=0. Thus, magnetic heads with the contact force of Fcl or smaller ones can be screened by rejecting those magnetic heads which separate from the disk when the rotational frequency of the disk is Rsl.

On the other hand, excessive contact force heads can be screened and rejected by only rejecting those magnetic heads which undergo no separation when the rotational frequency of the disk reaches the separation rotational frequency Rsu that is represented by the intersection between the separation straight line B for the contact force (e.g., Fcu) to be screened and the axis for Fc=0. If the value for the intersection Rsu between the separation straight line and the axis for Fc=0 exceeds the maximum allowable rotational frequency for the measuring device, as in the example shown in FIG. 9, however, the separation rotational frequency can be restricted to the allowable or lower value by reducing the mounting height for the proper ZH, as mentioned before. Thus, screening can be achieved by rejecting those magnetic heads which undergo no separation with the separation rotational frequency that is represented by the intersection between the axis of abscissa, indicative of the properly lowered ZH, and the separation straight line.

This invention is not limited directly to the embodiment described above, and in carrying out the invention, its components may be modified and embodied without departing from the scope or spirit of the invention. Further, various inventions may be made by suitably combining a plurality of components described in connection with the foregoing embodiment. For example, some of the components according to the above-described embodiment may be omitted. Furthermore, components of different embodiments may be combined as required.

For example, the set value of the ZH and the range of variation of the rotational frequency may be combined in any manner, depending on the allowable rotational frequency range for the measuring device, the range of the contact force to be measured, etc. Alternatively, the contact force may be measured with only the ZH or the rotational frequency varied. For example, the measurement may be made with only the ZH varied without changing the rotational frequency. If the device used cannot accept continuous change of the ZH, it is necessary only that the rotational frequency alone be changed with the ZH fixed at a certain value.

1. A method of screening a contact recording type magnetic head based on a contact force of the magnetic head, comprising:
preparing a head gimbal assembly having a suspension and a magnetic head supported on a distal end portion of the suspension by a gimbals spring;
rotating an inspection disk with a proximal end portion of the suspension supported at a given mounting height for a surface of the inspection disk and with the magnetic head in contact with the surface of the inspection disk; and
detecting separation of the magnetic head from the surface of the inspection disk with the rotational frequency of the inspection disk increased to a given value, thereby screening the magnetic head based on the performance of the separation.

2. The method of screening a contact recording type magnetic head according to claim 1, wherein magnetic heads having scarce contact forces are screened by rejecting those heads which undergo separation with a separation rotational frequency determined by a minimum contact force value to be screened, a disk rotational frequency of a magnetic disk drive, and the dependency of the contact force on the rotational frequency of the disk, or lower rotational frequencies.

3. The method of screening a contact recording type magnetic head according to claim 1, wherein magnetic heads having excessive contact forces are screened by rejecting those heads which undergo no separation with a separation rotational frequency determined by a maximum contact force value to be screened, a disk rotational frequency of a magnetic disk drive, and the dependency of the contact force on the rotational frequency of the disk, or higher rotational frequencies.

4. The method of screening a contact recording type magnetic head according to claim 1, wherein the detecting separation of the magnetic head includes detecting reproducing signal from the magnetic head, and detecting the separation in accordance with change of the half-width of the reproducing signal.

5. The method of screening a contact recording type magnetic head according to claim 1, wherein the detecting separation of the magnetic head includes detecting reproducing signal from the magnetic head, and detecting the separation in accordance with change of the intensity of the reproducing signal.

6. The method of screening a contact recording type magnetic head according to claim 1, wherein the detecting separation of the magnetic head includes detecting an acoustic emission signal from the proximal end portion of the suspension, and detecting the separation in accordance with change of the detected acoustic emission signal.

7. A method of measuring a contact force of a contact recording type magnetic head, comprising:
preparing a head gimbal assembly having a suspension and a magnetic head supported on a distal end portion of the suspension by a gimbals spring;
rotating an inspection disk with a proximal end portion of the suspension supported at a given mounting height for a surface of the inspection disk and with the magnetic head in contact with the surface of the inspection disk;
changing at least one of the mounting height of the suspension and the rotational frequency of the inspection disk so as to separate the magnetic head from the surface of the inspection disk;
detecting at least one of the mounting height of the suspension and the rotational frequency of the inspection disk, at which the magnetic head separates from the surface of the inspection disk; and
converting the detected mounting height and/or the rotational frequency of the inspection disk into the contact force of the magnetic head, thereby measuring the contact force.

8. The method of measuring a contact force of a contact recording type magnetic head according to claim 7, wherein the detecting separation of the contact recording type magnetic head includes gradually increasing the rotational frequency of the inspection disk from a reference rotational frequency with the mounting height above the inspection disk adjusted to an optional value smaller than a reference mounting height when the magnetic disk is rotated at the reference rotational frequency with the magnetic head mounted at the reference mounting height in a magnetic disk drive.

9. The method of measuring a contact force of a contact recording type magnetic head according to claim 7, wherein the contact force of the contact recording type magnetic head is obtained from a previously obtained rotational frequency sensitivity, which is indicative of a relation between the contact force of the magnetic head having a given reference rotational frequency and the rotational frequency of the magnetic disk, the mounting height for the separation of the magnetic head from the surface of the inspection disk, and the rotational frequency of the inspection disk.

10. The method of measuring a contact force of a contact recording type magnetic head according to claim 7, wherein the detecting separation of the magnetic head includes detecting reproducing signal from the magnetic head, and detecting the separation in accordance with change of the half-width of the reproducing signal.

11. The method of measuring a contact force of a contact recording type magnetic head according to claim 7, wherein the detecting separation of the magnetic head includes detecting reproducing signal from the magnetic head, and detecting the separation in accordance with change of the intensity of the reproducing signal.

12. The method of measuring a contact force of a contact recording type magnetic head according to claim 7, wherein the detecting separation of the magnetic head includes detecting an acoustic emission signal from the proximal end portion of the suspension, and detecting the separation in accordance with change of the detected acoustic emission signal.
